(19) United States
(12) Patent Application Publication
(10) Pub. No.: US 2004/0181702 A1
(43) Pub. Date: Sep. 16, 2004

(54) Method of saving power of computer

(75) Inventor: Chien-Sheng Cheng, Taipei (TW)

Correspondence Address: BACON & THOMAS, PLLC, 625 SLATERS LANE, FOURTH FLOOR, ALEXANDRIA, VA, 22314

(73) Assignee: First International Computer, Inc., Taipei (TW)

(21) Appl. No.: 10/386,496

(22) Filed: Mar. 13, 2003

(51) Int. Cl. G06F 1/32

(52) U.S. Cl. 713/320

(57) ABSTRACT

The present invention is to provide a method of saving power of a computer including an IR sensor thereon, a microprocessor chip, and a BIOS, the BIOS including a power saving program module which enables the IR sensor to detect whether there is a person present within a predetermined distance measured from the computer within a predetermined period of time; if the determination is negative, enabling the IR sensor to send an interrupt signal to the microprocessor chip so that the microprocessor chip will cause the computer to enter into a power saving mode according to a power saving setting content in the power saving program module.

### FIELD OF THE INVENTION

The present invention relates to saving power techniques and more particularly to a method of saving power of a computer such as notebook computer with improved characteristics.

### BACKGROUND OF THE INVENTION

Over the past several decades there has been a simultaneous growth in computer applications after inventing the computer. This also leads to an increasing use of their related products. Computers not only bring convenience but also are closely related to our daily life. As such, we can call this is an information age. Moreover, more people demand an information product (e.g., the increasing popular notebook computer) to be capable of providing advanced features and high quality as information technology continues to grow in an even faster pace. Thus, an indicator about whether information technology of one country is more advanced than other countries can be decided based on whether notebook computers produced by that country can provide a more convenient service, a more effective operation, and more ergonomic features.

Typically, a period of time, for example about one or more minutes, is required to boot or shut down one of a variety of commercially available computers (e.g., notebook computers or desktop computers). It is often that many people forget to shut down a running computer either unintentionally or in a hurry. This condition occurs when, for example, a superior officer of company calls the person to attend an unscheduled meeting or a client visits the company unexpectedly. As such, power is still consumed by the running, unattended computer. Power consumption of computer is mainly caused by an operating monitor or CPU (central processing unit) thereof. This is an energy waste. In another case that the computer was shut down normally when the above condition occurs. But the company meeting or the client visit is short. As such, the person has to reboot the computer after returning to his/her own seat in front of the computer. Such booting process may require about one or more minutes as stated above. It is understood that time spent on booting and shutdown is considerable if there are several such conditions occurred in a day. In other words, working time of a person is reduced, resulting in a lowering of efficiency.

Thus, it is desirable among manufacturers and consumers to provide a method of causing a computer to enter into a power saving mode when a user leaves the running computer for a predetermined period of time and causing the computer to return to an operating mode from the power saving mode after the user returning to his/her seat for operating the computer again.

### SUMMARY OF THE INVENTION

A primary object of the present invention is to provide a method of saving power of a computer. By utilizing this, the above drawback of the prior art can be overcome by understanding that a period of time is required to boot or shut down a notebook computer or desktop computer. The drawback is that a user often forgets to shut down a running computer either unintentionally or in a hurry after leaving the computer due to the occurring of an unexpected event. As such, power is still consumed by the unattended computer. Also, the user has to reboot the computer after returning to his/her own seat in front of the computer. Such rebooting may require some time, thus lowering work efficiency.

One object of the present invention is to provide a method of saving power of a computer including an IR sensor thereon, a microprocessor chip, and a BIOS, the BIOS including a power saving program module, responsive to running of the computer in an operating mode, enabling the IR sensor to transmit an IR signal and detecting whether there is a person present within a first predetermined distance measured from the computer; if the first determination is negative, enabling the IR sensor to transmit the IR signal again after the first predetermined period of time has passed and then again detecting whether there is a person present within the predetermined distance; and if the second determination is negative, enabling the IR sensor to send an interrupt signal to the microprocessor chip so that the microprocessor chip will cause the computer to enter into a power saving mode according to a power saving setting content in the power saving program module. As a result, it is possible of saving power of computer after the computer has not activated for a period of time.

The above and other objects, features and advantages of the present invention will become apparent from the following detailed description taken with the accompanying drawings.

### BRIEF DESCRIPTION OF THE DRAWINGS

FIG. 1 is a block diagram of main components of a computer for carrying out a method of saving power according to the invention;

FIG. 2 is a flow chart illustrating a sequence of steps performed by IR sensor shown in FIG. 1; and

FIG. 3 is a flow chart illustrating a sequence of steps performed by microprocessor chip shown in FIG. 1.

### DETAILED DESCRIPTION OF THE PREFERRED EMBODIMENTS

The invention is directed to a method of saving power of a computer by referring to a block diagram of main components of a computer (e.g., notebook computer) 1. On the computer 1 there is provided an IR (infrared) sensor 2. In the computer 1 there are provided a microprocessor chip 4 and a BIOS (Basic Input/Output System) 3 having a power saving program module 310. The IR sensor 2 can transmit an IR signal for detecting whether there is a person present within a predetermined distance measured from the computer 1 when the computer 1 is in an operating mode (i.e., powered on or reset). If no person being detected, the IR sensor 2 will transmit the IR signal again after a predetermined period of time has passed for detecting whether there is a person present. If still no person being detected, an interrupt signal will be sent to the microprocessor chip 4. In response, the microprocessor chip 4 will cause the computer 1 to enter into a power saving mode as commanded by a power saving setting content 320. After another period of time has passed, the IR sensor 2 will continuously transmit the IR signal for detecting whether there is a person present. If a person is detected, another interrupt signal will be sent to the microprocessor chip 4. In response, the microprocessor chip 4 will cause the computer 1 to return to the operating mode from the power saving mode. But if no person being detected, the computer 1 will remain at the power saving mode. Also, after another period of time has passed, the IR sensor 2 will continuously transmit the IR signal for detecting whether there is a person present.

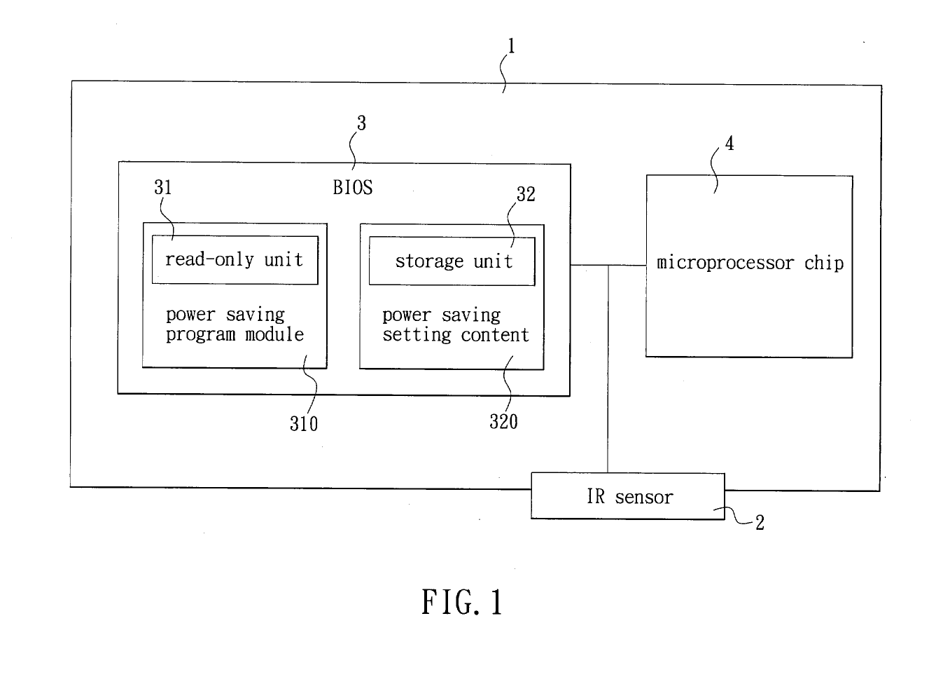

Referring to FIG. 1 again, the invention can identify whether a user is operating the computer 1 by activating the IR sensor 2 to transmit the IR signal in a direction in front of the computer. Following is a description of a temporary leaving of the user from the computer 1. For example, the user may either go to a printer location to refill papers if he/she finds that there is no paper available in the printer for printing or go to a water dispenser to pour water. The user is absent from the computer 1 temporarily in either case. Undesirably, the computer 1 enters into the power saving mode immediately if no person is detected by the IR sensor 2. Further, the computer 1 will return to the operating mode after the IR sensor 2 has detected the user who returns to his/her seat in front of the computer 1. However, such change of operating mode of computer due to short absence of user may consume a lot of time and thus cause inconvenience to the user. To the contrary, the invention does not implement the above conventional technique. Instead, in the invention the IR sensor 2 may detect a plurality of times (e.g., at least two times) for confirming whether the user is really leaving prior to causing the computer 1 to enter into the power saving mode. An interval between two adjacent detections can be preset depending on applications (e.g., 30 seconds). As a result, the computer 1 will not enter into the power saving mode immediately after a short leaving of the user. Otherwise, it can cause inconvenience to the user.

Referring to FIG. 1 again, in the invention the BIOS 3 comprises a read-only unit 31 and a storage unit 32. The read-only unit 31 is able to store the power saving program module 310. The read-only unit 31 is implemented as a ROM (read-only memory). The storage unit 32 is able to store the power saving setting content 320 containing the power saving mode. The storage unit 32 is implemented as a CMOS (complementary metal oxide semiconductor). A user can enter into the BIOS 3 for modifying the power saving mode of the power saving setting content 320. As to the power saving setting content 320, it may contain one of a variety of settings. For example, a backlight of a LCD (liquid crystal display) of the computer (e.g., notebook computer) 1 can be disabled temporarily. Alternatively, a CPU of the computer 1 is deactivated temporarily. Alternatively, the computer 1 may enter into a waiting mode directly without processing programs or data for reducing power consumption.

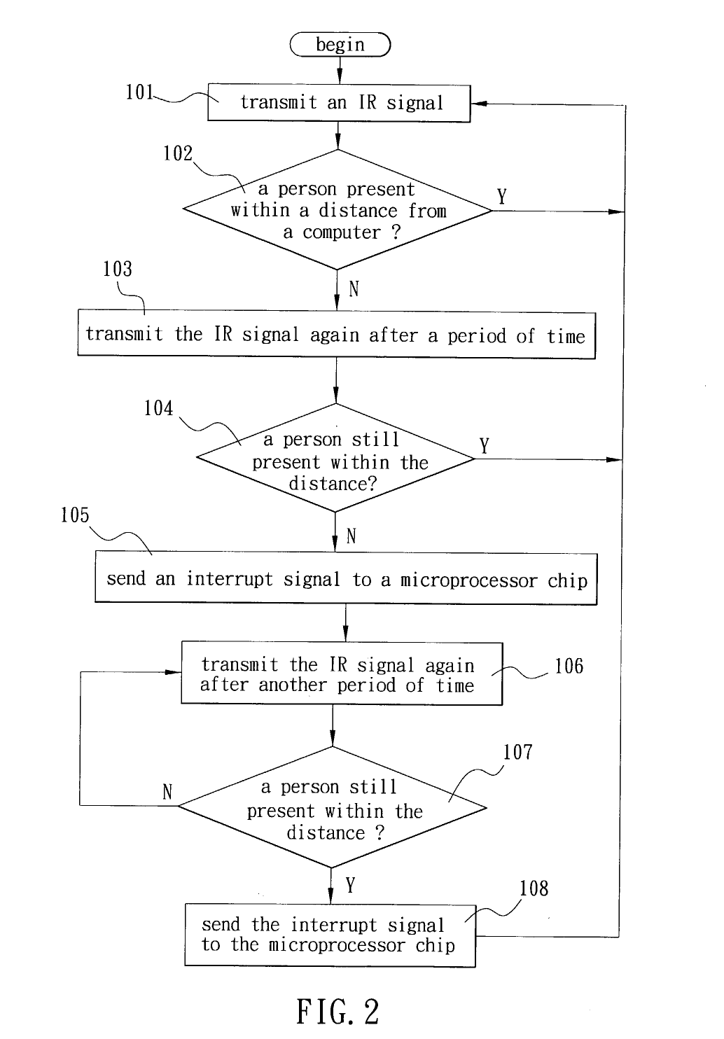

Referring to FIG. 2, there is shown a flow chart illustrating the following steps performed by the computer 1 in accordance with the power saving program module when it is in an operating mode:

In step 101, enabling the IR sensor 2 to transmit an IR signal.

In step 102, enabling the IR sensor 2 to detect whether there is a person present within a predetermined distance measured from the computer 1. If yes, the process returns to step 101. If not, the process goes to step 103.

In step 103, enabling the IR sensor 2 to transmit the IR signal again after a predetermined period of time has passed.

In step 104, enabling the IR sensor 2 again to detect whether there is a person present within the predetermined distance. If yes, the process loops back to step 101. Otherwise, the process goes to step 105.

In step 105, enabling the IR sensor 2 to send an interrupt signal to the microprocessor chip 4 activating the computer 1 entering into the power saving mode.

In step 106, after another period of time has passed, enabling the IR sensor 2 to transmit the IR signal again.

In step 107, enabling the IR sensor 2 to again detect whether there is a person present within the predetermined distance. If yes, the process goes to step 108. Otherwise, the process returns to step 106.

In step 108, enabling the IR sensor 2 to send another interrupt signal to the microprocessor chip 4 activating the computer 1 returning to the operating mode from the power saving mode and then looping back to step 101.

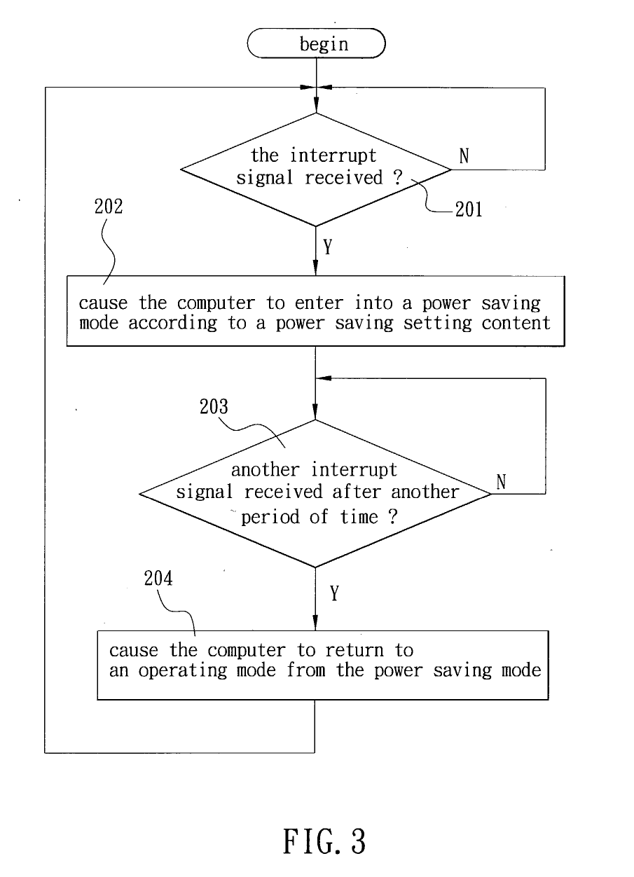

Referring to FIG. 3, there is shown a flow chart illustrating the following steps performed by the microprocessor chip 4 in response to the determination steps shown in FIG. 2:

In step 201, determining whether the interrupt signal has been received. If yes, the process goes to step 202. If not, the process returns to step 201.

In step 202, the microprocessor chip 4 will cause the computer 1 to enter into the power saving mode according to the power saving setting content 320.

In step 203, determining whether another interrupt signal has been received after another predetermined period of time has passed. If yes, the process goes to step 204. Otherwise, the process returns to step 203.

In step 204, enabling the computer 1 to return to the operating mode from the power saving mode prior to looping back to step 201.

While the invention has been described by means of specific embodiments numerous modifications and variations could be made thereto by those skilled in the art without departing from the scope and spirit of the invention set forth in the claims.

What is claimed is:

1. A method of saving power of a computer including an IR (infrared) sensor thereon, a microprocessor chip, and a BIOS (Basic Input/Output System) both therein, the BIOS including a power saving program module and a power saving setting content, wherein the method comprising the following steps performed by the computer in accordance with the power saving program module:
enabling the IR sensor to transmit an IR signal;
first determining whether the IR sensor detects a person present within a predetermined distance from the computer;
if the first determination is negative, enabling the IR sensor to transmit the IR signal again after a first predetermined period of time has passed;
second determining whether the IR sensor detects a person present within the predetermined distance;
if the second determination is negative, enabling the IR sensor to send a first interrupt signal to the microprocessor chip so that the microprocessor chip will cause the computer to enter into a power saving mode according to the power saving setting content;
enabling the IR sensor to transmit the IR signal after a second predetermined period of time has passed;
third determining whether the IR sensor detects a person present within the predetermined distance; and
if the third determination is positive, causing the IR sensor to send a second interrupt signal to the microprocessor chip so that the microprocessor chip will cause the computer to return to the operating mode from the power saving mode.

2. The method of claim 1, wherein the IR sensor will continuously transmit the IR signal after detecting the presence of a person within the predetermined distance.

3. The method of claim 1, wherein the IR sensor will continuously transmit the IR signal after detecting the presence of a person within the predetermined distance while the first predetermined period of time has passed.

4. The method of claim 1, wherein the IR sensor will continuously transmit the IR signal after detecting the presence of a person within the predetermined distance while the second predetermined period of time has passed.

5. The method of claim 1, wherein the BIOS further comprises a read-only unit for storing the power saving program module and a storage unit for storing the power saving setting content containing the power saving mode so as to enable a person to enter into the BIOS for modifying the power saving mode of the power saving setting content.

6. The method of claim 5, wherein the read-only unit is a ROM (read-only memory).

7. The method of claim 5, wherein the storage unit is a CMOS (complementary metal oxide semiconductor).

8. The method of claim 1, wherein in the power saving setting content a backlight of a LCD (liquid crystal display) of the computer is disabled temporarily.

9. The method of claim 1, wherein in the power saving setting content the computer is commanded to enter into a waiting mode directly without processing programs or data.
